(19) United States
(12) Patent Application Publication
(10) Pub. No.: US 2025/0015635 A1
(43) Pub. Date: Jan. 9, 2025

(54) SMALL DOMESTIC APPLIANCE DEVICE

(71) Applicant: BSH Hausgeräte GmbH, Munich (DE)

(72) Inventors: Santiago Miguel De Ena Wolf, Zaragoza (ES); Maria Parra Borderías, Zaragoza (ES); Jesus Ceamanos Gaya, Zaragoza (ES); David Valeau Martin, Zaragoza (ES); Maria Carmen Albero Mena, Zaragoza (ES); Beatriz Villanueva Valero, Zaragoza (ES); Carlos Franco Gutierrez, Zaragoza (ES); Carlos Casion Ballester, Zaragoza (ES)

(21) Appl. No.: 18/710,641

(22) PCT Filed: Dec. 1, 2022
(86) PCT No.: PCT/EP2022/084148

§ 371 Date: May 16, 2024

(30) Foreign Application Priority Data
Dec. 3, 2021 (EP) 21383111.8

(51) Int. Cl. H02J 50/10; H02J 7/00

(52) U.S. Cl. CPC H02J 50/10; H02J 7/0045

(57) ABSTRACT

A small household appliance device, in particular a small kitchen appliance device, includes a functional unit, and an energy storage module including a rechargeable energy store and designed to supply energy to the functional unit. The energy store contains lithium iron phosphate and/or nickel metal hydride.

The invention relates to a small household appliance device as claimed in the preamble of claim 1, an energy storage module as claimed in claim 11, a small household appliance as claimed in claim 12 and a small household appliance system having at least two small household appliances and at least one energy storage module as claimed in claim 13.

A plurality of very different small household appliances, in particular small kitchen appliances, is already known from the prior art. Small household appliances with a higher energy requirement, for example mixers and the like, have hitherto generally been supplied with energy by way of a cable. Small household appliances with a low energy requirement, for example temperature gauges and the like, are generally operated using single-use batteries. However, the use of single-use batteries is no longer appropriate and is rejected by many users for environmental reasons. Some small household appliances with rechargeable batteries configured as lithium ion batteries based on lithium cobalt (III) oxide (LiCoO₂) are also known. However, in particular for small kitchen appliances, the use of lithium ion batteries containing LiCoO₂ has the disadvantage of being extremely limited and not expedient or reliable for very many applications as lithium ion batteries based on LiCoO₂ can only be operated safely within specific temperature ranges due to the risk of fire and/or explosion. In addition the significant temperature fluctuations occurring in the case of cooking applications also result in the problems of rapid discharge and/or premature degradation of lithium ion batteries based on LiCoO₂. There is therefore a need for alternative rechargeable energy stores for small household appliances.

The object of the invention is in particular, although not solely, to provide a generic device with improved properties in respect of efficiency. According to the invention the object is achieved by the features of claim 1, while advantageous embodiments and developments of the invention will emerge from the subclaims.

The invention is based on a small household appliance device, in particular a small kitchen appliance device, having at least one functional unit and having at least one energy storage module, which has at least one rechargeable energy store and is provided to supply energy to the functional unit.

It is proposed that the energy store contains lithium iron phosphate and/or nickel metal hydride.

Such an embodiment advantageously results in a small household appliance with a particularly high level of efficiency, in particular material efficiency. Because the energy storage module has at least one rechargeable energy store, wireless and therefore particularly flexible operation is advantageously possible, thereby improving user friendliness. At the same time there is advantageously no need for single-use batteries. This advantageously saves resources and reduces waste. It allows a particularly sustainable and/or environmentally friendly small household appliance device to be provided. Because the energy store contains lithium iron phosphate and/or nickel metal hydride, safety and reliability levels are higher than with conventional small household appliances with lithium ion batteries based on LiCoO₂ in particular. The fire and/or explosion risk is advantageously reduced. The energy store will advantageously last for a particularly long time and have a long life. There is also advantageously no need to use cobalt, which is a rare and expensive element, thereby improving cost efficiency. It is also advantageously possible to comply with current and/or future regulations for portable energy stores, for example the EU Battery Directive.

A “small household appliance device” refers to at least a part, in particular a sub-assembly, of a small household appliance and/or at least an accessory part for a small household appliance. For example the small household appliance could contain the small household appliance device, in particular where the small household appliance device is part of the small household appliance. Alternatively or additionally the small household appliance device could be configured as an accessory for the small household appliance and be provided for use with the small household appliance. The small household appliance device, in particular the small kitchen appliance device, can also comprise the entire small household appliance, in particular the entire small kitchen appliance.

The small household appliance is a freely locatable household appliance, which contains at least the small household appliance device and can also contain further assemblies and/or units and/or elements, which are not part of the small household appliance device. “Freely locatable” here means that the small household appliance can be placed anywhere, and in particular without aids, by a user in a household setting, in particular in contrast to a large household appliance, which is positioned and/or installed permanently in a specific position in a household setting, for example an oven or a refrigerator or a cooktop. The small household appliance is preferably configured as a small kitchen appliance and in an operating state provides at least one household appliance function for processing food. The small household appliance could be configured but is not restricted to being configured for example as a multifunction food processor and/or a mixer and/or a stirrer and/or a grinder and/or kitchen scales or as a kettle or a coffee machine or a rice cooker or a milk frother or a deep fat fryer or a toaster or a juicer or a slicing machine or a temperature gauge. The small household appliance can also be for example a cooking utensil with at least one electrically operated additional function, in particular a pot or skillet with an integrated temperature sensor or the like.

When the small household appliance device is in an operating state, the functional unit provides at least one small household appliance function. Depending on the nature of the small household appliance containing the small household appliance device, the small household appliance function can be one of various functions, for example a cooking function and/or a warming function and/or a keeping warm function and/or a stirring function and/or a sensor function.

The energy storage module has a main functionality in the form of supplying energy to the functional unit. The energy storage module preferably has at least one function beyond the pure supplying of energy to the functional unit, for example a display function. The energy store is provided to store electrical energy in a charge state and to supply the functional unit in a discharge state. The energy store is preferably configured as a battery and has at least one positive electrode made of lithium iron phosphate (LiFEPO₄) and/or nickel (II) hydroxide and at least one negative electrode made of graphite with stored lithium and/or a metal hydride. The energy store can be configured as a lithium iron phosphate battery or a nickel metal hydride battery for example. The energy storage module could contain just one energy store. Alternatively the energy storage module could also contain multiple energy stores. In the case of an energy storage module containing multiple energy stores the energy stores could be connected electrically parallel and/or electrically in series to one another and be provided for the simultaneous supply of energy to the functional unit. In the case of an energy storage module containing multiple energy stores it is alternatively or additionally also conceivable for at least a first energy store to be provided to supply energy for the operation of a first functional element of the functional unit and at least a second energy store to be provided to supply energy for the operation of a second functional element of the functional unit. In the case of an energy storage module containing multiple energy stores it is also conceivable for at least a first energy store to be provided to supply energy to the functional unit over a first time period and at least a second energy store to be provided to supply energy to the functional unit over a second time period. In the case of an energy storage module containing multiple energy stores all the energy stores can be configured identically, for example as batteries of the same type, of the same shape and size and with the same characteristic values, for example power, nominal voltage and the like. It would also be conceivable for at least two energy stores of the energy storage module to be different in respect of type and/or shape and/or size and/or at least one characteristic value. For example the first energy store could be configured as a lithium iron phosphate battery and a second energy store of the energy storage module could be configured as a nickel metal hydride battery. The energy store(s) could be connected detachably to the energy storage module. The energy store(s) is/are preferably integrated permanently in the energy storage module.

In the present document numerical words, such as “first” and “second” preceding specific terms are only used to differentiate objects and/or to assign between objects and do not imply any total number and/or ranking of the objects. In particular a “second object” does not necessarily imply the presence of a “first object”.

“Provided” means specifically programed, designed and/or equipped. That an object is provided for a specific function means in particular that the object performs and/or executes said specific function in at least one application and/or operating state.

The energy storage module could be connected permanently to the functional unit. In one advantageous embodiment it is proposed however that the energy storage module has a connecting unit with at least one connecting element for establishing a detachable connection to the functional unit. This advantageously increases flexibility. The connecting unit is provided to establish a detachable connection between the energy storage module and the functional unit and has at least one connecting element for this purpose. The connecting unit can have multiple connecting elements, which can be configured in the same manner or differently from one another. The connecting element could be provided to establish a mechanical connection between the energy storage module and the functional unit and could be configured for example as a latching element, for example a latching hook and/or a latching recess or the like, without being restricted thereto. It would also be conceivable, alternatively or additionally, for the connecting element to be provided for a magnetic connection between the energy storage module and the functional unit.

The connecting element could be provided solely to establish the detachable connection between the energy storage module. In one particularly advantageous embodiment it is proposed however that, when the connection is established between the energy storage module and the functional unit, the connecting element is provided to transfer energy from the energy store to the functional unit. Such an embodiment advantageously increases efficiency. Material efficiency in particular can be increased if, when the connection is established between the energy storage module and the functional unit, the connecting element is provided to transfer energy from the energy store to the functional unit.

It is also proposed that, when the connection between the energy storage module and the functional unit is detached, the connecting element is provided to establish a connection to a power supply network and to charge the energy store by way of the power supply network. This advantageously increases efficiency further. Material and/or cost efficiency in particular can be increased if, when the connection is established between the energy storage module and the functional unit, the connecting element is provided to transfer energy from the energy store to the functional unit and, when the connection between the energy storage module and the functional unit is detached, the connecting element is provided to establish a connection to a power supply network and to charge the energy store by way of the power supply network, as this advantageously dispenses with any need for further connecting elements.

It is also proposed that the connecting element has at least one micro-USB type and/or USB-C type and/or Lightning type connector. Such an embodiment advantageously improves user friendliness. Because the connecting element has a micro-USB type and/or USB-C type and/or Lightning type connector, a user can advantageously use any chargers already available for mobile terminals, such as smartphones, tablets and the like, to charge the energy store. This advantageously results in a cost saving. Resources can advantageously also be saved, as there is no need for an additional charger or charging cable to charge the energy store. The connecting element could have multiple connectors, in particular a micro-USB type connector and a further USB-C type connector and/or a further Lightning type connector. It is also conceivable for the connecting element to have just one connector, a micro-USB type connector or a USB-C type connector or a Lightning type connector. The single connector could be part of the connecting element and the connecting element could also comprise further elements, for example latching elements and/or locking elements and/or the like. In the case of a single connector the connecting element is preferably configured as the micro-USB type connector or USB-C type connector or Lightning type connector.

It is also proposed that the energy storage module has an energy intake unit with at least one inductive intake element for charging the energy store inductively. Such an embodiment advantageously improves operating convenience. The inductive intake element preferably comprises at least one secondary coil and/or is configured as a secondary coil. The energy intake unit can comprise multiple inductive intake elements. In the case of an energy intake unit with multiple inductive intake elements, these can be provided for simultaneous inductive charging, for example to achieve a particularly fast charging speed. It is also conceivable for a first inductive intake element of the energy intake unit to be provided to couple with a primary coil of a first type and a second inductive intake element of the energy intake unit to be provided to couple with a primary coil of a second type that is different from the first type.

It is also proposed that the energy intake unit is provided to charge the energy store inductively by means of an external charger to the Qi standard. This advantageously further improves operating convenience and user friendliness. The external charger could be an accessory part of the small household appliance device and/or of the small household appliance containing the small household appliance device. The external charger is preferably an external charger that is independent of the small household appliance device and/or the small household appliance containing the small household appliance device, which is provided for charging at least one mobile terminal, for example a smartphone and/or tablet, to the Qi standard. To charge the energy store a user can then advantageously use a charger that is already available for charging mobile terminals wirelessly to the Qi standard. This advantageously reduces costs. Resources can also advantageously be saved, as a Qi standard charger can be used to charge different devices. The Qi standard developed by the Wireless Power Consortium (WPC) for the wireless transfer of energy by means of electromagnetic induction over short distances is designed for powers between 5 Watt and 15 Watt and to date has mainly been established for charging mobile terminals such as smartphones, tablets and the like. If the energy intake unit is provided to charge the energy store inductively by means of a Qi standard external charger, said standard can advantageously be established beyond the application for mobile terminals.

It is also proposed that the energy intake unit is provided to charge the energy store inductively by means of a supply unit of an induction cooking appliance, in particular to the Ki standard. Such an embodiment advantageously further improves flexibility and operating convenience. The Ki standard, which is currently still being developed by the Wireless Power Consortium (WPC), is provided for supplying energy wirelessly to small household appliances by means of induction cooktops, it being possible to supply powers of up to 2,200 Watt inductively.

It is further proposed that the energy storage module has a control unit for monitoring and protecting the energy store. This advantageously results in a particularly safe, reliable and durable small household appliance device. The control unit preferably comprises a battery management system with at least one electronic circuit for monitoring and protecting the energy store. The battery management system of the control unit can also be provided to control and/or regulate charging and/or discharging operations of the energy store. Functions of the control unit can include, but are not restricted to, for example charge state detection, deep discharge protection, overcharge protection, short circuit protection, control and/or regulation processes of a charging operation based on a characteristic charging curve of the energy store.

It is also proposed that the small household appliance device has an output unit for outputting a status of the energy storage module and/or the functional unit. This advantageously improves operating convenience. The output unit can be provided to output a status of the energy storage module, for example a state of connection to the functional unit and/or a power supply network and/or a charge state of the energy store. Alternatively or additionally the output unit could be provided to output at least one status of the functional unit, for example a current operating state and/or an operating mode or at least one operating parameter, for example a speed or a measured temperature or the like. To output the status of the energy storage module and/or the functional unit the output unit has at least one output element. The output element could be configured as an acoustic output element, for example a speaker. Alternatively or additionally the output element could be configured as an optical output element, for example a display. The output unit preferably has at least one output element, which is configured as lighting element, in particular an LED, preferably an RGB-LED.

The invention also relates to an energy storage module for a small household appliance device according to one of the embodiments described above. Such an energy storage module is characterized in particular by its advantageous properties in respect of efficient and flexible use.

The invention also relates to a small household appliance, in particular a small kitchen appliance, having a small household appliance device according to one of the embodiments described above. Such a small household appliance is characterized in particular by the above-mentioned advantageous properties of the small household appliance device.

The invention also relates to a small household appliance system, in particular a small kitchen appliance system, having at least two small household appliances and having at least one energy storage module according to one of the embodiments described above. This advantageously results in a small household appliance system with a particularly high measure of efficiency, flexibility and operating convenience. The small household appliance system can have just one energy storage module, which can be connected as required to at least one functional unit of the at least two small household appliances respectively to supply energy. Alternatively the small household appliance system can also have multiple energy storage modules configured substantially identically to one another, which can be connected as required to each of the functional units of all the small household appliances of the small household appliance system to supply energy. It is also conceivable for the small household appliance system to have at least one small household appliance with a functional unit having a higher power requirement, for example a stirrer or the like, it being possible for said functional unit to be connected to at least two energy storage modules simultaneously to cover the higher power requirement.

The small household appliance device here should not be restricted to the application and embodiment described above. In particular, to comply with a mode of operation described herein, the small household appliance device can have a different number of individual elements, parts and units from the number cited herein.

Further advantages will emerge from the description of the drawing which follows. The drawing shows an exemplary embodiment of the invention. The drawing, description and claims contain numerous features in combination. The person skilled in the art will expediently also consider the features individually and combine them in useful further combinations.

In the drawing:

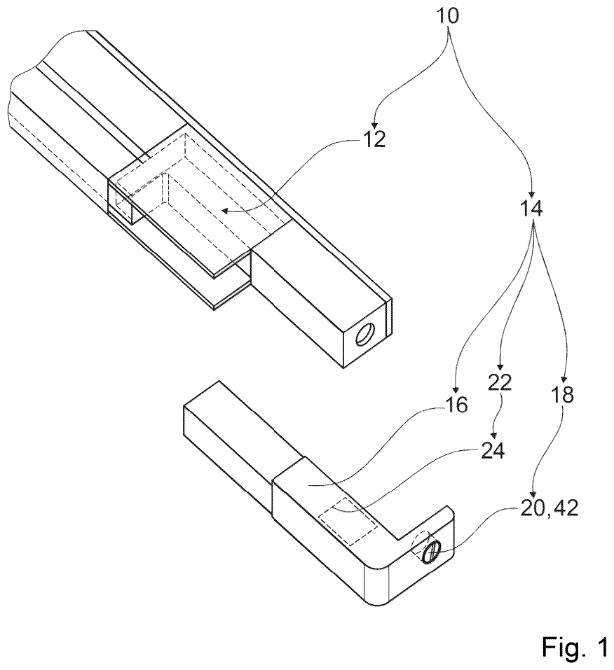

FIG. 1 shows a schematic diagram of a small household appliance device having a functional unit and having an energy storage module,

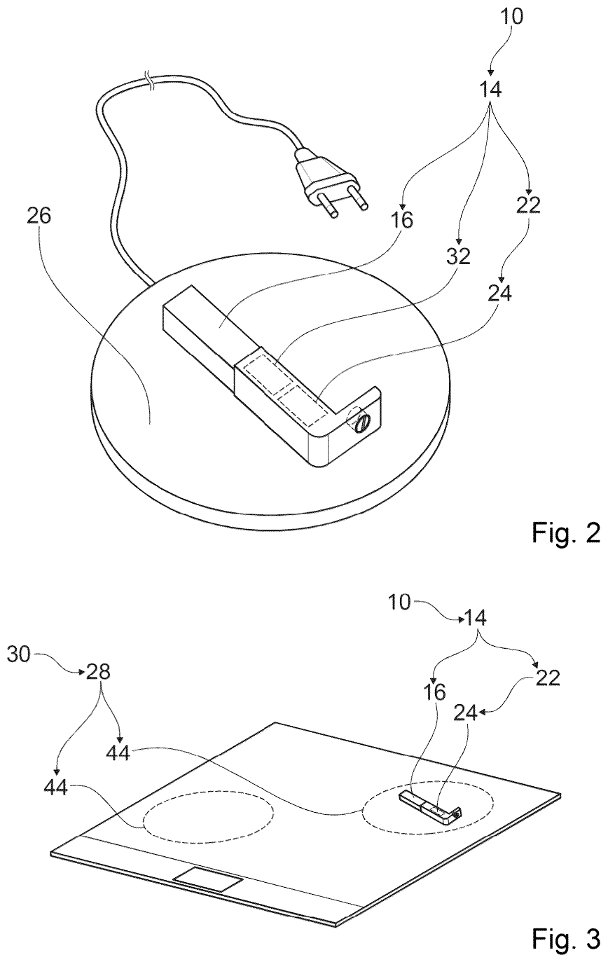

FIG. 2 shows a schematic diagram of the energy storage module with an external charger,

FIG. 3 shows a schematic diagram of the energy storage module with an induction cooking appliance, and

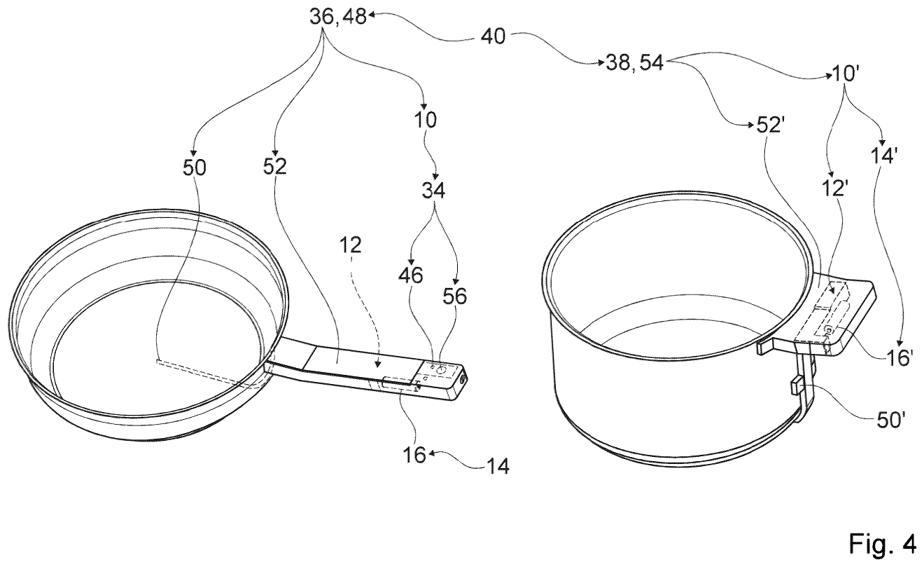

FIG. 4 shows a schematic diagram of a small household appliance system having two small household appliances and the energy storage module.

FIG. 1 shows a schematic diagram of a small household appliance device 10. The small household appliance device 10 here is configured as a small kitchen appliance device.

The small household appliance device 10 has at least one functional unit 12. The small household appliance device 10 here has just the one functional unit 12. In the present exemplary embodiment the functional unit 12 is configured as a sensor unit, specifically a temperature sensor unit of a small household appliance 36 (see FIG. 4).

The small household appliance device 10 has at least one energy storage module 14. The energy storage module 14 has at least one energy store 16. The energy store 16 is provided to supply energy to the functional unit 12.

The energy store 16 contains lithium iron phosphate and/or nickel metal hydride. In the present exemplary embodiment the energy store 16 is configured as a lithium iron phosphate battery. Alternatively the energy store 16 could be configured as a nickel metal hydride battery. The energy storage module 14 here has just one energy store 16. However the energy storage module 14 could also contain the energy store 16 and at least one further energy store (not shown). The further energy store could be configured substantially identically to the energy store 16 or could differ from this at least to some extent, for example in type and/or shape and/or size and/or at least one characteristic value, for example a power and/or nominal voltage. The further energy store could be configured for example as a nickel metal hydride battery.

The energy storage module 14 has a connecting unit 18. The connecting unit 18 has at least one connecting element 20 to establish a detachable connection to the functional unit 12.

When the connection is established between the energy storage module 14 and the functional unit 12 (see FIG. 4), the connecting element 20 is provided to transfer energy from the energy store 16 to the functional unit 12.

When the connection between the energy storage module 14 and the functional unit 16 is detached, the connecting element 20 is provided to establish a connection to a power supply network (not shown).

The connecting unit 18 has at least one micro-USB type and/or USB-C type and/or Lightning type connector 42. The connecting element 20 here is configured as the micro-USB type and/or USB-C type and/or Lightning type connector 42. In the present exemplary embodiment the connector 42 is configured for example as a micro-USB type connecting socket. The connecting unit 18 could have further connectors (not shown) of the USB-C type and/or Lightning type. To charge the energy store 16, a user can connect the energy storage module 14 to the power supply network by way of the connector 42 by means of a conventional micro-USB type charger (not shown) provided for a smartphone for example. When the connection is established between the energy storage module 14 and the functional unit 12, energy is also supplied to the functional unit 12 by way of the connecting element 20 configured as a connector 42. The functional unit 12 accordingly has a micro-USB type connecting socket (not shown) for this purpose.

FIG. 2 shows a schematic diagram of the energy storage module 14 together with an external charger 26. The energy storage module 14 has an energy intake unit 22. The energy intake unit 22 has at least one inductive intake element 24 for charging the energy store 16 inductively. The inductive intake element 24 is configured as a secondary coil.

The energy intake unit 22 is provided to charge the energy store 16 inductively by means of the external charger 26 to the Qi standard. The external charger 26 could be configured as an accessory part for the household appliance device 10. The external charger 26 here is however a charger for the wireless charging of mobile terminals, for example smartphones and/or tablets, to the Qi standard. In a charging state the external charger 26 supplies a power between 5 and 15 Watt to charge the energy store 16. The external charger 16 has at least one primary coil (not shown) for this purpose, coupled to the inductive intake element 24 of the energy intake unit 22 configured as a secondary coil, when the energy storage module 14 is placed on the external charger 26.

The energy storage module 14 has a control unit 32 for monitoring and protecting the energy store 16. The control unit 32 comprises a battery management system having at least one electronic circuit (not shown), which is provided to monitor, control and/or regulate and to protect the energy store 16. Functions of the control unit 32 can include but are not restricted to for example charge state detection, deep discharge protection, overcharge protection, short circuit protection, control and/or regulation processes of a charging operation based on a characteristic charging curve of the energy store 16 and the like.

FIG. 3 shows a schematic diagram of the energy storage module 14 together with an induction cooking appliance 30. The induction cooking appliance 30 here is configured as an induction cooktop and has a supply unit 28 having at least one inductive supply element 44.

The energy intake unit 22 is provided to charge the energy store 16 inductively by means of the supply unit 28 of the induction cooking appliance 30, in particular to the Ki standard.

FIG. 4 shows a schematic diagram of a small household appliance system 40. The small household appliance system 40 comprises at least two small household appliances 36, 38 and at least one energy storage module 14. The small household appliance 36 here is configured by way of example as a skillet 48 with integrated temperature sensor element 50. The small household appliance 36 contains the small household appliance device 10. The functional unit 12 of the small household appliance device 10 is integrated in a handle 52 of the small household appliance 36. The temperature sensor element 50 is connected to the functional unit 12 configured as a temperature sensor unit.

The small household appliance device 10 has an output unit 34. The output unit 34 is provided to output a status of the energy storage module 14 and/or the functional unit 12. The output unit 34 has at least one output element 46. The output element 46 here is configured as an LED, specifically an RGB-LED. When the small household appliance device is in an operating state, the output element 46 outputs a status of the energy storage module 14. For example in the operating state the output element 46 displays a connection status between the functional unit 12 and the energy storage module 14. When the connection is established between the energy storage module 14 and the functional unit 12 by means of the connecting unit 18, the output element 46 could shine blue for example. When the connection between the energy storage module 14 and the functional unit 12 is broken, the output element 46 could flash red for example. In the operating state the output element 46 is also provided to output a charge status of the energy store 16. When the energy store is in the fully charged state for example the output element 46 could shine green and as the charge state diminishes its color could change from green through yellow to red.

The output unit 34 has a further output element 56. The further output element 56 is provided to output a status of the functional unit 12 and can be configured for example as an LCD display or the like. In the operating state the output unit 34 outputs a temperature of a skillet base of the skillet 48 detected by the temperature sensor element 50 by way of the further output element 56 for example.

The output unit 34 here is arranged in the energy storage module 14. Alternatively however the output unit 34 could also be arranged in its entirety or partially on the functional unit 12. It is also conceivable for the output unit 34 to be arranged partially in the energy storage module 14 and partially on the functional unit 12. It would be conceivable for example for the output element 46 to be arranged on the energy storage module 14 to output a status of the energy storage module 14 and for the further output element 56 to be arranged on the functional unit 12 to output a status of the functional unit 12.

A further household appliance 38 of the small household appliance system 40 is a pot 54 with integrated temperature sensor element 50′. The small household appliance 38 has a small household appliance device 10′, which is configured substantially identically to the small household appliance device 10. The small household appliance device 10′ has a functional unit 12′ configured as a temperature sensor unit, which is integrated in a handle 52′ of the further small household appliance 38. The small household appliance device 10′ has an energy storage module 14′, which is configured substantially identically to the energy storage module 14 of the small household appliance device 10. The energy storage modules 14, 14′ are interchangeable, in other words the energy storage module 14 and the energy storage module 14′ can both be used both to supply energy to the functional unit 12 and to supply energy to the functional unit 12′. The small household appliance system 40 here contains the two interchangeable energy storage modules 14, 14′. However it would also be conceivable as an alternative for the small household appliance system 40 only to contain the energy storage module 14, which could then be used as required with one of the two small household appliances 36, 38 to supply energy to one of the two functional units 12, 12′.

### REFERENCE CHARACTERS

10 Small household appliance device
12 Functional unit
14 Energy storage module
16 Energy store
18 Connecting unit
20 Connecting element
22 Energy intake unit
24 Inductive intake element
26 External charger
28 Supply unit
30 Induction cooking appliance
32 Control unit
34 Output unit
36 Small household appliance
38 Further small household appliance
40 Small household appliance system
42 Connector
44 Inductive supply element
46 Output element
48 Skillet
50 Temperature sensor element
52 Handle
54 Pot
56 Further output element

1-13. (canceled)

14. A small household appliance device, in particular a small kitchen appliance device, the small household appliance device comprising:
a functional unit; and
an energy storage module comprising a rechargeable energy store and designed to supply energy to the functional unit, said energy store containing lithium iron phosphate and/or nickel metal hydride.

15. The small household appliance device of claim 14, wherein the energy storage module comprises a connecting unit which includes a connecting element designed to establish a detachable connection to the functional unit.

16. The small household appliance device of claim 15, wherein the connecting element is designed to transfer energy from the energy store to the functional unit, when the connection is established between the energy storage module and the functional unit.

17. The small household appliance device of claim 15, wherein, when the connection between the energy storage module and the functional unit is detached, the connecting element is designed to establish a connection to a power supply network and to charge the energy store by way of the power supply network.

18. The small household appliance device of claim 15, wherein the connecting element is configured as a micro-USB type and/or USB-C type and/or Lightning type connector.

19. The small household appliance device of claim 14, wherein the energy storage module comprises an energy intake unit which includes an inductive intake element designed to charge the energy store inductively.

20. The small household appliance device of claim 19, wherein the energy intake unit is designed to charge the energy store inductively via an external charger according to a Qi standard.

21. The small household appliance device of claim 19, wherein the energy intake unit is designed to charge the energy store inductively by a supply unit of an induction cooking appliance, in particular according to a Ki standard.

22. The small household appliance device of claim 14, wherein the energy storage module comprises a control unit designed to monitor and protect the energy store.

23. The small household appliance device of claim 14, further comprising an output unit designed to output a status of the energy storage module and/or the functional unit.

24. An energy storage module for a small household appliance device, the energy storage module comprising a rechargeable energy store and designed to supply energy to a functional unit of the small household appliance device, said energy store containing lithium iron phosphate and/or nickel metal hydride.

25. The energy storage module of claim 24, further comprising a connecting unit which includes a connecting element designed to establish a detachable connection to the functional unit.

26. The energy storage module of claim 25, wherein the connecting element is designed to transfer energy from the energy store to the functional unit, when the connection is established between the energy storage module and the functional unit.

27. The energy storage module of claim 25, wherein the connecting element is designed to establish a connection to a power supply network and to charge the energy store by way of the power supply network, when the connection between the energy storage module and the functional unit is detached.

28. The energy storage module of claim 25, wherein the connecting element is configured as a micro-USB type and/or USB-C type and/or Lightning type connector.

29. The energy storage module of claim 24, further comprising an energy intake unit which includes an inductive intake element designed to charge the energy store inductively.

30. The energy storage module of claim 29, wherein the energy intake unit is designed to charge the energy store inductively via an external charger according to a Qi standard.

31. The energy storage module of claim 29, wherein the energy intake unit is designed to charge the energy store inductively by a supply unit of an induction cooking appliance, in particular according to a Ki standard.

32. The energy storage module of claim 24, further comprising a control unit designed to monitor and protect the energy store.

33. A small household appliance, in particular a small kitchen appliance, the small household appliance comprising the small household appliance device as set forth in claim 14.

34. A small household appliance system, comprising:
at least two small household appliances; and
an energy storage module designed to supply energy to a functional unit of the at least two small household appliances, said energy storage module comprising a rechargeable energy store which contains lithium iron phosphate and/or nickel metal hydride.
